(19) United States
(12) Patent Application Publication
(10) Pub. No.: US 2005/0232298 A1
(43) Pub. Date: Oct. 20, 2005

(54) Early direct memory access in network communications

(76) Inventors: Harlan T. Beverly, McDade, TX (US); Hemal V. Shah, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/828,369

(22) Filed: Apr. 19, 2004

(51) Int. Cl. H04L 12/56

(52) U.S. Cl. 370/463; 370/394; 370/252

(57) ABSTRACT

A network offload engine having a first buffer to store packet payloads that are received at the network offload engine until being copied to a location in a receive buffer of a host memory. An engine is programmed to copy contents of the first buffer to the location in the receive buffer of the host memory in response to meeting a first precondition. Host notification of the copy is postponed until a second precondition is met. Other embodiments are also described.

### BACKGROUND

Specific subject matter disclosed herein relates to the field of computer networking. Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a protocol known as Transmission Control Protocol (TCP) provides “connection” services that enable remote applications to communicate. That is, much like a telephone company ensuring that a call will be connected when placed by a subscriber, TCP provides applications with simple primitives for establishing a connection (e.g., CONNECT and CLOSE) and transferring data (e.g., SEND and RECEIVE). TCP transparently handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. The payload of a segment carries a portion of a stream of data sent across a network. A receiver can restore the original stream of data by collecting the received segments.

Potentially, segments may not arrive at their destination in their proper order, if at all. For example, different segments may travel very different paths across a network. Thus, TCP assigns a sequence number to each data byte transmitted. This enables a receiver to reassemble the bytes in the correct order. Additionally, since every byte is sequenced, each byte can be acknowledged to confirm successful transmission.

Many computer systems and other devices feature host processors (e.g., general purpose Central Processing Units (CPUs)) that handle a wide variety of computing tasks. Often these tasks include handling network traffic. The increases in network traffic and connection speeds have placed growing demands on host processor resources. To at least partially alleviate this burden, a network protocol off-load engine can off-load different network protocol operations from the host processors. For example, a TCP Off-Load Engine (TOE) can perform one or more TCP operations for sent/received TCP segments.

### BRIEF DESCRIPTION OF DRAWINGS

Embodiments of the invention may best be understood by referring to the following description and accompanying drawings that are used to illustrate certain embodiments of the invention. In the drawings:

FIG. 1 illustrates a system according to an embodiment.

FIG. 2 is a flow diagram illustrating operation according to an embodiment of the system of FIG. 1.

### DETAILED DESCRIPTION

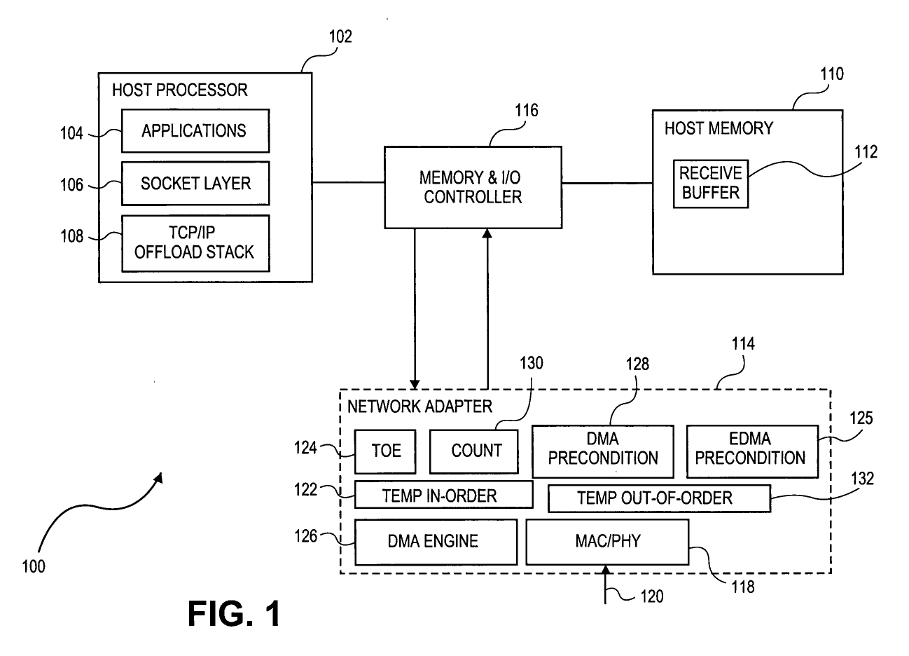

In the following description, specific subject matter disclosed herein relates to the field of copying packet payloads from offload engines to a host memory. The packets may be copied via Direct Memory Access (DMA) transactions during network communications when a precondition is met for copying packets from the offload engine to the host memory. For example, when an Early DMA (EDMA) precondition is met, one embodiment performs DMA copying of received packets to a host memory prior to notifying the host of the DMA copy and prior to the received packets meeting a DMA precondition for the DMA copy to occur. The DMA and EDMA preconditions are data items representative of a system 100 state (see FIG. 1), e.g., a predetermined period of time, a certain number of bytes having been appended to a queue, etc.

Although both DMA and EDMA copies operate as DMA transactions, the copies are referred to herein as DMA and EDMA copy operations to distinguish DMA transactions where the host is notified, and DMA transactions where the host is not notified. The packets may be received at the offload engine via a network transmission protocol such as Universal Data Protocol (UDP) that does not require packets to be in order for operation. Alternatively, packets may be received via Transmission Control Protocol (TCP) that does require packets to be in order for operation. Specific details of certain embodiments of the present invention are set forth. However, it is understood that embodiments of the invention may be practiced without these specific details and that other implementations may be used without departing from the invention.

The phrase “network communication link” as used herein refers to an apparatus for transmitting information from a source to a destination over any one of several types of data transmission media such as, for example, unshielded twisted pair wire, coaxial cable, fiber optic, etc. However, this is merely an example of a network communication link and embodiments of the present invention are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and embodiments of the present invention are not limited in this respect.

FIG. 1 illustrates a system 100 according to an embodiment. The system 100 may include a host processor 102 illustrated as being capable of hosting processes such as a socket layer 106, TCP/IP offload stack 108 and applications 104. The processes hosted on the host processor 102 may interoperate with a host memory 110 that includes, among other things, a receive buffer 112 for packet payloads that may be received in the system 100.

The packets may be received using, among other protocols such as UDP, a TCP protocol. TCP segments may be received through a network adapter 114 which comprises a TOE engine 124. The network adapter 114 is illustrated communicating with the host processor 102 and host memory 110 through a memory and input/output (I/O) controller 116. The network adapter 114 may be coupled to the memory and I/O controller 116 in a variety of ways, e.g., a PCI-Express bus, a PCI-X bus, some other type of a bus, or possibly integrated with a core logic chipset providing the memory and I/O controller 116.

During TCP communications, the memory and I/O controller 116 may act as the interface between the host processor 102 and the network adapter 114 by arbitrating read and write access to the host memory 110. Thus, the memory and I/O controller 116 enables the host processor 102 to communicate with the network adapter 114 during packet reception through buffers predefined in the host memory 110.

A packet may be received at the medium access control/physical layer (MAC/PHY) 118 on a network communication link 120. Although the MAC/PHY 118 is illustrated as a single entity that is integrated into the network adapter 114, embodiments are contemplated in which the MAC portion may be integrated into the network adapter 114 while the PHY is not. The network communication link 120 may operate according to any one of several different data link protocols such as IEEE Std. 802.3, IEEE Std. 802.11, IEEE Std. 802.16, etc. over any one of several data transmission media such as, for example, a wireless air interface or cabling (e.g., coaxial, unshielded twisted pair or fiber optic). The packet may be appended to a temp in-order queue 122 where TOE engine 124 determines whether a precondition has been met to copy the temp in-order queue 122 to the receive buffer 112. The copy to the host memory 110 may be a DMA copy when a “DMA precondition” is met as described earlier, or the copy may be a DMA copy when an “EDMA precondition” is met.

Preconditions 125 and 128 are shown as data items that may represent one or more system 100 states in which the temp in-order queue 122 may be copied to the receive buffer 112 of the host memory 110. In the presently illustrated embodiment, the precondition 128 may represent whether the aforementioned DMA precondition is met and the precondition 125 may represent whether the aforementioned EDMA precondition is met. Although preconditions may be met in many ways, either of the preconditions 125 and 128 may be set when a predetermined period of time has passed since receiving packets at the temp in-order queue 122, at which time the TOE engine 124 may proceed with a DMA copy from the network adapter 114 to the host memory 110. This type of copy may be referred to herein as a “DMA transaction.” In other embodiments, the preconditions 125 and 128 may be set when a certain number of bytes have been received in the temp in-order queue 122. In still other embodiments, the preconditions 125, 128 may be set when sufficient data is available (in the in-order queue 122) to completely fill the receive buffer 112. The preconditions 125, 128, may also be set when the receive buffer 112 reaches a ‘threshold,’ e.g., a certain percentage full of data. Still other states may be contemplated for setting the preconditions 125, 128.

An EDMA precondition 125 may be met many times prior to the DMA precondition 128 being met. For example, the TOE engine 124 may recognize that the system 100 has met an EDMA precondition 125 and then instruct DMA engine 126 to perform a DMA copy of the temp in-order queue 122 to the receive buffer 112. Because this DMA copy occurs when the EDMA precondition 125 is met, the copy is sometimes referred to herein as an EDMA copy.

The precondition 125 is a data item that represents a particular system 100 state (e.g., when the aforementioned EDMA precondition is met). When the precondition 125 is set in the system 100, the TOE engine 124 may be enabled to begin a DMA copy from the temp in-order queue 122 without notifying the host processor 102. The host processor 102 is not notified by the TOE engine 124 until the precondition 128 is set (e.g., when the aforementioned DMA precondition is met), possibly after multiple EDMA copies have occurred. Thus, when each EDMA copy occurs, the TOE engine 124 may create a count 130, per TCP connection, to track the next location in the receive buffer 112 to begin placing bytes in the following EDMA transaction without overwriting previously transferred bytes.

The precondition 128 is a data item representing the system 100 state in which the host processor 102 as well as the TOE engine 124 are notified that a DMA transaction may occur (e.g., when the aforementioned DMA precondition is met). Upon receiving this first notification at the host processor 102 that the DMA precondition 128 has been met, the EDMA transactions have already either mostly or fully completed the DMA transaction from the temp in-order queue 122 such that the host processor 102 may be notified almost immediately by the TOE engine 124 that the DMA transaction from the temp in-order queue 122 has completed.

The preconditions 125 and 128 may enable the TOE engine 124 to perform a DMA copy to host memory 110 of bytes in the temp in-order queue 122 when either the DMA or EDMA precondition is met. All bytes will be copied from the temp in-order queue 122 unless, as described below, such copy would exceed the number of bytes that are allowed to be DMA copied when the DMA precondition 128 is met.

For example, based on the number of bytes in the receive buffer 112, the TOE engine 124 may not proceed with a complete EDMA transaction because the DMA precondition 128 will be met prior to completion of the EDMA copy. The preconditions 125 and 128 may be provided to the network adapter 114 by the host processor 102 or other supervisory device. The preconditions 125 and 128 may also be a data item received remotely over an out of-band network, and be received prior to any data being copied from the temp in-order queue 122 to the receive buffer 112, but not necessarily prior to data being stored in temporary buffers.

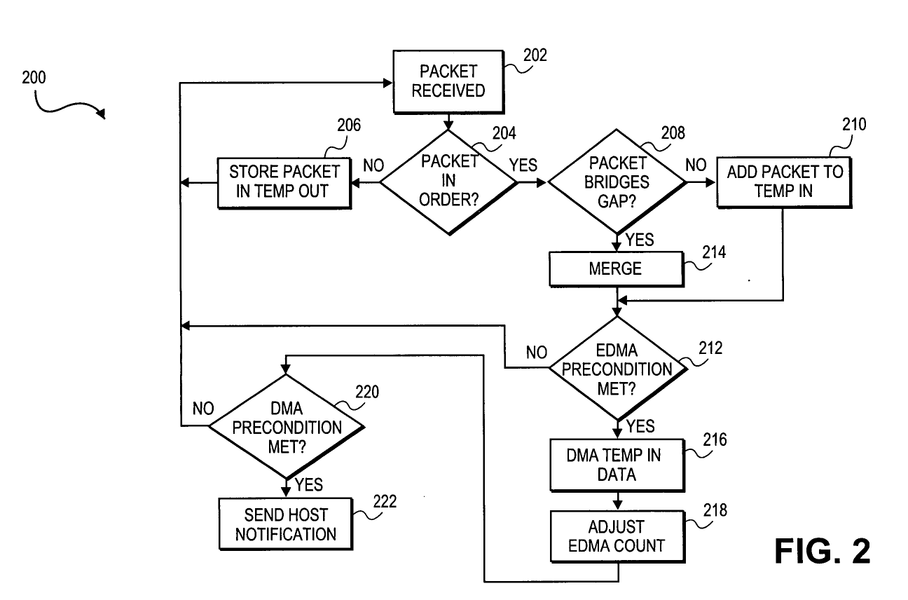

FIG. 2 is a flow diagram illustrating a process 200 according to an embodiment of the system 100. The process 200 may occur in the network adapter 114 with firmware that is running on an embedded processor, with a state machine, or with a combination of a state machine and the firmware running on the embedded processor. In general, as described in relation to FIG. 1, network transmissions of packets that remain in order, or that do not follow TCP (e.g., UDP) may be received at the network adapter 114 and DMA copied to the receive buffer 112 immediately when the EDMA precondition 125 is met. However, at block 202 a packet may be received from a network communication link such as the link 120 and analyzed at diamond 204 to determine whether it is in order with other packets that have been received. If the packet is out of order, at block 206 the packet is stored in the temp out of-order queue 132 and the process 200 returns to block 202 for receiving a new packet.

If the packet is found to be in order at diamond 204, the packet may be analyzed at diamond 208 to determine whether the packet is also adjacent to the next out of order packet, i.e., whether the packet “bridges the gap” with other out of order packet(s) that have been stored in the out of-order queue 132. If the packet does not bridge the gap, at block 210 the packet is added to the in-order queue 122 where the in-order queue 122 may be analyzed at diamond 212 to determine whether the EDMA precondition 125 has been met by the new number of bytes in the in-order queue 122. If diamond 212 determines that the EDMA precondition 125 has not been met, the process 200 returns to block 202 for receiving a new packet 202.

If diamond 204 determines that the packet is in order and diamond 208 determines that the packet bridges the gap, at block 214 packet(s) from the out of-order queue 132 are merged with the packets in the in-order queue 122 to further fill the in-order queue 122. The merge 214 bridges whatever gap that may exist between the most recently received packet of the in-order queue 122 and the out of-order queue 132. For example, in one case, bridging the gap may introduce a single packet into the in-order queue 122 from the out of-order queue 132, while in another case, closing the gap may introduce more than one packet into the in-order queue 122 because more than one packet in the out of-order queue 132 was in order except for the new in-order queue 122 packet. When the gap between the in-order queue 122 packets and the out of-order queue 132 packets is bridged, the remaining out of-order queue 132 packets may create a new gap between queues 122 and 132. However, prior to a new gap existing between the in-order queue 122 and the out of-order queue 132, diamond 212 may determine whether the EDMA precondition 125 has now been met. If diamond 212 determines that the EDMA precondition 125 has been met, data from the in-order queue 122 may be DMA copied to the receive buffer 112 at block 216. Block 218 may then adjust the EDMA count to accommodate the DMA copies from the in-order queue 122.

Diamond 220 may determine whether the DMA precondition 128 has been met. If the DMA precondition 128 is not met, the process 200 returns to block 202 for receiving a new packet. If diamond 220 determines that the DMA precondition 128 has been met, block 222 may initiate a notification to the host for further processing. Because of the EDMA precondition 125, at this stage in DMA copies, most data may already have been copied to the receive buffer 112 and notification confirmation from the host of a successful DMA copy from the in-order queue 122 may occur almost immediately, e.g., without waiting on DMA copy latencies.

Data movement may occur independently of the host processor 102 being notified by the network adapter 114 that the data movement may occur, i.e., notification of the DMA precondition 128 being met may be separated from actual movement of data to the receive buffer 112. For example, in certain embodiments, the receive buffer 112 may be identified by the descriptor “RECEIVE_MESSAGE”, where a “RECEIVE_MESSAGE” may be a data structure that the host processor 102 may use to communicate multiple items regarding the DMA copy transactions.

The RECEIVE_MESSAGE is often associated with a TCP connection identification or file handle and may include data items to represent the DMA and/or EDMA preconditions 125 and 128. Although controlling software does not perform checks as to whether preconditions have been met, the controlling software utilizes the DMA precondition 125 of the RECEIVE_MESSAGE for host processor 102 notification when the receive buffer 112 fits a particular condition, e.g., the receive buffer 112 is filled to a certain capacity of bytes, a time-out is met, a threshold or maximum capacity of the receive buffer 112 is met, etc. The controlling software may be located in both the host processor 102 and in the network adapter 114 with the main control loop executing in the host processor 102. The controlling software of the network adapter 114 may perform the precondition checks with the data items from the RECEIVE_MESSAGE.

In addition, the RECEIVE_MESSAGE may include a combination of the buffer size and buffer location for the receive buffer 112 and may be represented as a scatter-gather list of memory locations. Further, host processor 102 notification that data movement has occurred may be carried out in other ways. For example, a message descriptor may be written to a buffer and then the controlling software may access the message descriptor in response to an interrupt.

According to an embodiment, in order to avoid overwriting data in the receive buffer 112, a device (such as the network adapter 114) may maintain a count of the number of data bytes which have already been EDMA copied to the receive buffer 112 for each RECEIVE_MESSAGE or connection. Alternatively, since only one RECEIVE_MESSAGE may be active/recognized per connection, only one count need be maintained per connection. That count (e.g., count 130) may be increased whenever data may be delivered early into the receive buffer 112 (i.e., prior to the DMA precondition 128) which is referenced by the RECEIVE_MESSAGE. When the DMA precondition 128 is met, rather than copying all of the data at that time, most (or all) of the data has already been DMA copied to the receive buffer 112.

When data is to be copied to the receive buffer 112, the DMA engine 126 may consider the count 130 when determining a destination address. In general, the count 130 may indicate the position that data may begin being placed into the receive buffer 112 relative to the previous DMA copy to prevent overwriting of data within the receive buffer 112 that was received from a previous DMA copy. In this manner, the DMA engine 126 calculates where the next DMA operation should start. It should be understood that this general case is sufficient for implementing early DMA for a simple case of packets arriving in order. In more complicated scenarios, TCP packets may arrive in arbitrary order and additional steps may be added to perform early DMA copies.

According to an embodiment, the TCP protocol enforces maintaining a proper ordering of received packets. For that reason, out of-order data may be kept separate from in-order data. Accordingly, when out of-order data arrives, no early DMA can occur on that out of-order data; instead it is kept in an out of-order temporary storage area (such as the out of-order queue 132). While in-order data may be early DMA copied, out of-order data may not be early DMA copied because it is unknown which RECEIVE_MESSAGE buffer is ultimately destined to be given the out of-order data.

Thus, when new in-order data arrives the network adapter 114 compares the numbering of the new in-order data with the numbering of the out of-order data to see if the new in-order data may be combined with the existing in-order data and the out of-order data that was previously received. This is done according to TCP protocols (checking the sequence numbers of each packet received). If the new in-order data does generate a sequential pattern with previously received in- and out of-order data (based on TCP sequence number comparisons), the sequential portion of the out of-order queue 132 may be combined with the new in-order data and the in-order queue 122 to make a new larger in-order queue 122. This operation may occur independently of the decision to early DMA, and may be accomplished by changing a pointer of a linked list or a data copy.

When new in-order data arrives, the network adapter 114 may check a current RECEIVE_MESSAGE for EDMA authorization through an EARLY_DMA field being set. Thus, an EARLY_DMA may be authorized per RECEIVE_MESSAGE for each connection. However, multiple RECEIVE_MESSAGEs may accumulate on a given connection, but only the first may be active at a given time until the RECEIVE_MESSAGE has met the DMA precondition. Thus, there may be one count per connection as well as one count per RECEIVE_MESSAGE.

If RECEIVE_MESSAGE is not authorized for EARLY_DMA, then all received data must wait in the “in-order” temporary area (e.g., in-order queue 122) until such time as the DMA precondition 128 has been met, such as when sufficient data has arrived. When the DMA precondition 128 has been met, all the received data may be DMA copied to the receive buffer 112 at once. If EARLY_DMA is authorized then, in one case, the offload engine 114 checks if enough data has accumulated in the in-order queue 122 (typically a linked list of packet buffers for TCP) to satisfy the EDMA precondition 125 (on a per connection or a per RECEIVE_MESSAGE basis), and DMA copies the in-order queue 122 to host memory when the EDMA precondition 125 is met.

For example, a user might wish to perform an EARLY_DMA operation if 256 bytes have accumulated in the in-order queue 122. Of course, the EDMA precondition 125 may be set for other conditions in the system 100 and data may be kept as a linked list in the in-order queue 122 until the EDMA precondition 125 is met. If the EDMA precondition 125 is met, an EARLY_DMA request is made to the DMA engine 126. The DMA engine 126 may copy the data which has accumulated in the in-order queue 122 to the receive buffer 112 (pointed to by the RECEIVE_MESSAGE) up to the maximum allowed by the RECEIVE_MESSAGE or successful completion of the DMA precondition 128.

To track the amount of data that may have been previously EARLY_DMA copied, two fields of the RECEIVE_MESSAGE may control. First, each RECEIVE_MESSAGE may have an associated count 130 (e.g., EDMA_COUNT field) which simply increments by one for each byte which the DMA engine EARLY_DMA copies to the receive buffer 112. However, for purposes of knowing how much additional data may be EARLY_DMA copied into the receive buffer 112, and to decide if sufficient threshold has accumulated in the in-order queue 122, a second field such as another count 130 may be kept in a Process Control Block (PCB) of the TCP protocol called ‘Backlog’. The Backlog variable may represent a count of the number of bytes which have been received at the in-order queue 122 but not yet DMA copied or “completed” because neither precondition 125 or 128 has been met. By comparing the ‘Backlog’ count to the EDMA_COUNT, it may be determined how many more bytes may be copied from the in-order queue 122. If the EDMA_COUNT has reached the maximum allowed for a given RECEIVE_MESSAGE no further data may be early DMA copied and the Backlog remains until another receive buffer is made available or the connection is terminated.

Regardless of whether EARLY_DMA is authorized by the appropriate RECEIVE_MESSAGE field, controlling software may check for whether the DMA precondition 128 has been met at the receive buffer 112. If the DMA precondition 128 is met (e.g., receive buffer 112 is full), completion notification may be made to the controlling software that this RECEIVE_MESSAGE is complete. If EARLY_DMA was NOT authorized by this RECEIVE_MESSAGE and the receive buffer 112 has room for the additional data, all of the data should be copied prior to host 102 notification that the DMA transaction has completed. If EARLY_DMA is authorized by this RECEIVE_MESSAGE, when the DMA precondition 128 is met, the possibility exists that no data may be copied because the data may have already been copied due to EARLY_DMA and host 102 notification may follow without delay.

If another RECEIVE_MESSAGE is ready, then the system 100 may proceed to the next RECEIVE_MESSAGE except for the posting of RECEIVE_MESSAGEs, which occurs in the host processor 102. The RECEIVE_MESSAGEs may be generated from the applications 104 using the socket layer 106 of the host processor 102.

Late posting of a RECEIVE_MESSAGE may also be supported. In the case that a RECEIVE_MESSAGE is not posted at all, data may accumulate in the in-order queue 122 (e.g., a linked list of packet buffers). When a RECEIVE_MESSAGE is posted, and at least one additional data item is received, the DMA engine 126 may note that the EDMA precondition 125 may be met, and thus certain portions of the RECEIVE_MESSAGE data may be DMA copied early. This may be useful for protocol applications such as Internet Small Computer System Interface (iSCSI), Network File Systems (NFS), and Common Internet File System (CIFS) or the like which rely on the indicate-and-post method for receiving data.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the invention has been described in terms of several embodiments, those of ordinary skill in the art should recognize that the invention is not limited to the embodiments described, but can be practiced with modification and alteration within the spirit and scope of the appended claims. The description is thus to be regarded as illustrative instead of limiting.

1. A method of receiving packets comprising:
setting a first and a second precondition to indicate when to begin copying at least one packet payload from a first buffer of an offload engine to a receive buffer of a host memory;
receiving at least one packet at the offload engine from a network communication link,
appending a packet payload of the at least one packet to the first buffer of the offload engine;
determining whether the first precondition has been met based, at least in part, on a state of the first buffer;
determining whether the second precondition has been met based, at least in part, on the state of the first buffer;
copying at least a portion of the first buffer of the offload engine to the receive buffer of the host memory if the first precondition has been met; and
repeating the method until the second precondition has been met.

2. The method of claim 1 further comprising receiving another packet from the network communication link if the second precondition has not been met.

3. The method of claim 1 further comprising increasing a count to offset future copies from the first buffer to the host memory.

4. The method of claim 1 wherein said copying at least a portion of the first buffer to the receive buffer comprises copying a portion of the packet payload.

5. The method of claim 4 wherein said copying at least a portion of the first buffer to the receive buffer comprises copying the portion of the packet payload as well as at least one previously received packet payload of the first buffer.

6. The method of claim 1 wherein said copying the at least a portion of the first buffer of the offload engine to the receive buffer of the host memory comprises a DMA copy of the at least a portion of the first buffer and releasing the at least a portion of the first buffer.

7. The method of claim 1 wherein the first precondition comprises a predetermined percentage of the first buffer of the offload engine being filled with payload data.

8. The method of claim 1 wherein the first precondition comprises a predetermined number of bytes in the first buffer of the offload engine.

9. The method of claim 1 wherein the first precondition comprises a predetermined time period having passed since said setting of the first precondition.

10. A network offload engine comprising:
a first interface to receive packets from a network communication link;
a first buffer to store packet payloads of at least some of the received packets;
a second interface to a host memory to copy the packet payloads that are stored in the first buffer to a receive buffer in the host memory in response to a first precondition;
logic to copy contents of the first buffer to a location in the receive buffer of the host memory in response to the first precondition being met, the logic to notify a host in response to meeting a second precondition;
a count device to offset the location in the receive buffer where the contents of the first buffer are to be copied, the offset being relative to the received packet payloads that have already been copied from the first buffer to the receive buffer.

11. The network offload engine of claim 10 wherein the count device stores a number representing the number of bytes that have been copied from the first buffer to the receive buffer.

12. The network offload engine of claim 10 further comprising a direct memory access engine to copy payload data from the first buffer to the receive buffer.

13. The network offload engine of claim 10 wherein the network communication link comprises a cable for Ethernet communication.

14. A system comprising:
a host processor to host applications for receiving packets;
a host memory having a receive buffer to store packet payload data received from a network communication link communicating with the host;
an unshielded twisted pair communication link to transmit packets; and
a network offload engine to receive the packet payload data in a first buffer, the network offload engine having an engine to copy the packet payload data in the first buffer to the receive buffer of the host memory independently of notification of the host processor and in response to the first buffer meeting a first precondition, the engine to notify the host processor in response to a second precondition being met.

15. The system of claim 14 wherein the network offload engine further comprises a direct memory access engine for copying the packet payload data in the first buffer to the receive buffer.

16. The system of claim 14 wherein the unshielded twisted pair communication link comprises an Ethernet adapter.

17. An article comprising:
a storage medium of a network adapter comprising machine-readable instructions stored thereon to:
set a first and a second precondition to copy received packets in a first buffer of a network offload engine of the network adapter to a receive buffer at a host memory in response to, at least in part, meeting the first precondition at the network adapter;
append a packet payload to the first buffer of the offload engine;
access with an engine of the offload engine a flag that indicates whether the first precondition has been met by said appending the packet payload to the first buffer of the offload engine;
access with the engine another flag that indicates whether the second precondition has been met by the packet payload being appended to the first buffer in view of previous packet payloads that have been appended to the first buffer;
copy at least a portion of the first buffer of the offload engine to the receive buffer of the host memory in response to meeting the first precondition; and
repeat the method each time the first precondition has been met until meeting the second precondition.

18. The article of claim 17 wherein the storage medium further comprises machine-readable instructions to increase a count when the at least a portion of the first buffer is copied to the receive buffer, the count to offset future copies from the first buffer to the receive buffer.

19. The article of claim 17 wherein the storage medium further comprises machine-readable instructions to copy the at least a portion of the first buffer to the receive buffer without notifying a host processor.

20. The article of claim 17 wherein the storage medium further comprises machine-readable instructions to receive packets at the first buffer.

21. A method comprising:
setting a first and a second precondition in a system for receiving packets;
receiving packets of a network transmission at a network offload engine of the system;
copying at least a portion of the received packets to a host buffer without notifying a host processor in response to the system meeting the first precondition;
re-setting the first precondition;
repeating the method until meeting the second precondition;
notifying the host that the second precondition has been met; and
copying any remaining of the received packets in the network offload engine to the host buffer after said notifying the host.

22. The method of claim 21 wherein said copying the at least a portion of the received packets of the offload engine to the host buffer without notifying the host processor comprises copying the at least a portion of the received packets prior to receiving all of the packets of the network transmission.

23. The method of claim 21 wherein said receiving packets of the network transmission at the network offload engine comprises receiving packets at a first buffer of the network offload engine.
